(19) United States
(12) Patent Application Publication
(10) Pub. No.: US 2010/0159815 A1
(43) Pub. Date: Jun. 24, 2010

(54) PREFILTER FOR SPRAY PAINT BOOTH AND METHOD OF REDUCING CONTAMINATION

(75) Inventors: Thomas J. Reid, White Bear Lake, MN (US); John D. Stelter, Hudson, WI (US); Troy K. Ista, River Falls, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/623,599

(22) Filed: Nov. 23, 2009

Related U.S. Application Data
(60) Provisional application No. 61/139,052, filed on Dec. 19, 2008.

(51) Int. Cl. B05B 15/12; B01D 46/10; B01D 50/00

(52) U.S. Cl. 454/53; 55/350.1

(57) ABSTRACT

A particulate filtration system is provided for protecting a substrate to be painted from wet or dry particulates the result from overspray. The filtration system includes a particulate filter, a grate, and a two-dimensional prefilter. The filtration system can be used, for example, in spray painting booths for painting vehicles.

### RELATED APPLICATION DATA

This application claims the benefit of U.S. Provisional Application No. 61/139,052, filed Dec. 19, 2008.

### FIELD

The present disclosure relates to systems, structures, and methods for protecting a substrate from wet or dry particulates that result from overspray. More specifically, this disclosure relates prefilters used in particulate filtration systems.

### BACKGROUND

In collision repair facilities, painting operations are often carried out in paint booths. A paint booth is an enclosed structure capable of being heated to very high temperatures, and it typically contains interior surfaces made of coated metal or other heat resistant materials. Painting operations are conducted in paint booths in order to contain paint overspray produced during the painting operation as well as to provide a controlled environment for curing paint finishes. During painting operations, paint booth floors and interior surfaces are often contaminated with paint overspray, making the floors and interior surfaces of the paint booth difficult and time consuming to clean.

In downdraft paint spray booths, a filter pit can be located in the floor of the paint spray booth. The object to be painted, usually a vehicle, can be driven into the paint spray booth and located just above the filter pit. Downdraft paint spray booths allow air to flow from air supply plenems that can be located in the ceiling or one or more of the side walls of the paint spray booth to an air exhaust system below the floor in the filter pit. This downward airflow allows paint spray byproducts such as solvent or overspray to flow down and away from the vehicle reducing exposure of the workers and the freshly painted vehicle to wet or dry particulates from the paint spray operation. The filter pit is typically supplied with a particulate filter positioned below the grate to remove wet and/or dry particulates from the exhaust air. If desired, the filtered air can then be recirculated and reused. Since vehicles can be driven into the paint spray booths, the filter pits and filters contained therein are typically covered with one or more grates that allow air to flow into the air exhaust system but also allow the vehicle to drive over them and to avoid falling into the filter pit. Additionally work carts, paint stands, and painters routinely stand on the grates while working. During use, the grates can also accumulate dried paint particles

The accumulation of dried paint particles known as “dried overspray” can cause defects in freshly painted surfaces by being dislodged from the grates and being deposited onto freshly painted surfaces. To avoid costly rework the grates have to be routinely removed and cleaned of dried overspray, typically by sanding and finishing the inner walls of the grates. In addition, the filters have to be replaced. This cleaning process can be costly and time consuming, often taking the paint booth out of service while maintenance is done. Likewise, the walls and windows of the paint booth also have to be routinely cleaned in a similar manner.

### SUMMARY

Thus, there is a need for a way to prevent dried overspray contamination of painted articles by accumulated dried paint particles on the floor grate of paint spray booths. There is also a need to protect filter pit grates from such accumulation. Finally, there is a need for filtering the air flow in a paint booth so as to reduce the amount of airborne particulates that could otherwise contaminate the surfaces of freshly painted articles.

In one aspect, a particulate filtration system is provided that includes a grate having a grate having an upstream surface and a downstream surface opposite the upstream surface; a two-dimensional prefilter located in proximity to the upstream surface of the grate; and a particulate filter located in proximity to the downstream surface of the grate.

In another aspect, a structure for painting an article is provided that includes an enclosure having a floor, an exhaust air filter pit in the floor, a grate mounted in the exhaust air filter pit, a two-dimensional prefilter overlying an upper surface of the grate, and a particulate filter in proximity to and beneath the grate.

In yet another aspect, a method of reducing contamination is provided that includes providing a painting structure that includes a work space, a floor, a ceiling, at least two side panels, and a particulate filtration system located in the floor; introducing an article into the work space; spraying the article with paint; circulating air from at least one of the ceiling or the side panels around the article to form particulate-laden air; passing the particulate-laden air through a particulate filtration system located in the floor to an exhaust system; and allowing the paint to dry in the circulating air, wherein the particulate filtration system includes a grate having an upstream surface and a downstream surface opposite the upstream surface; a two-dimensional prefilter located in proximity to the upstream surface of the grate; and a particulate filter located in proximity to the downstream surface of the grate.

In this disclosure:

“grate” refers to a barrier that protects the entry to an air exhaust system where the barrier is sufficiently open to allow for air to pass through it but prevents sizable objects from passing;

“nonwoven” refers to a textile structure produced by bonding or interlocking of fibers, or both, accomplished by mechanical, chemical, thermal, or solvent means and combinations in accordance with ASTM D123-03;

“woven” refers to a structure produced when at least two sets of strands are interlaced, usually at right angles to each other, according to a predetermined pattern of interlacing, and such that at least one set is parallel to the axis along the lengthwise direction of the fabric, in accordance with ASTM D123-03;

“overspray” and “overspray particles” refer to droplets or particulates of paint that do not impinge and adhere to the object being painted and can, for example, contaminate nearby surfaces, and which, after drying, can form particulates that can break loose and contaminated the painted object;

“proximity” refers to located near or next to and includes in contact with and not in contact with but close to. In the context of this disclosure proximity means within the airflow channel of;

“resilient” refers to a material that is capable of being repeatedly subjected to vehicular traffic without loss of integrity, i.e., linting; and

“two-dimensional” refers to essentially flat and thus to an object, such as a filter, that has two significant dimensions with the third dimension (thickness or height) being much smaller than the other two dimensions, for example less than 1% of the dimension of the next smallest dimension.

The disclosed particulate filtration system, structures for painting an article that includes the provided particulate filtration system, and methods of reducing contamination that includes the provided particulate filtration system provide means to reduce dried overspray contamination of painted articles caused by accumulated dried paint particles on the floor grate of the structures. The disclosed system, structures, and methods help to protect filter pit grates from such accumulations by providing a resilient two-dimensional prefilter located in proximity to the upstream surface of the grate. The disclosed particulate filtration system including the disclosed prefilter provides an inexpensive system that can reduce contamination from dried overspray.

The above summary is not intended to describe each disclosed embodiment of every implementation of the present invention. The brief description of the drawing and the detailed description which follows more particularly exemplify illustrative embodiments.

### BRIEF DESCRIPTION OF THE DRAWINGS

FIG. 1 is an exploded view of an embodiment of a particulate filtration system.

FIG. 2 is an illustration of an embodiment of a provided structure for painting vehicles.

FIG. 3 is a cut-away view of a filter pit that includes an embodiment of a provided particulate filtration system.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The provided particulate filtration system includes a grate having an upstream surface and a downstream surface opposite the upstream surface opposite the upstream surface. The grate can be of any size or configuration. It should be made of a material and of a configuration such that it can support the weight of a vehicle that may be driven over it. The grate can be made of any strong material such as, for example, iron, steel, metal alloys, composites, or even polymers. In structures useful for painting an article, the grate can be a part of or embedded in the floor of the structure. The grate can be of any shape but typically is square or rectangular in shape. The grate can be one piece or can be comprised of several pieces that fit together. In some embodiments where the structure is a paint spray booth useful for painting vehicles, there can be a filter pit in the floor of the workspace where the vehicle is painted. In these embodiments, it is typical to have the grate fit into the filter pit so that the grate can be flush with the floor and that any vehicles being moved into the workspace can be driven over and/or onto the grate and not fall into the filter pit. The grate can form a porous cover over the filter pit that permit airflows to pass through it so that airborne overspray paint can be directed to a filter that is positioned below the grate and in the filter pit with the filter being designed to remove the airborne paint droplets or particulates. The grate inevitably receives a gradual accumulation of buildup from the airborne paint droplets or particulates with the result that the grate openings are gradually reduced in size to the point that adequate airflow therethrough is no longer possible. Additionally, accumulated buildup on the grate can result in dried particulates on the grate breaking off in the airflow stream, bouncing off the grate or floor, and contaminating any freshly painted surface on the article being painted. Therefore, the grate requires periodic removal and cleaning by various paint stripping processes that necessarily imposes a time, space, and cost penalty to the operator of the painting facility.

The provided particulate filtration system includes a particulate filter located in proximity to the downstream surface of the grate. The downstream surface of the grate is on the downstream side of airflow through the grate. The particulate filter can be any filter that can remove dried paint particulates or wet paint spray droplets. The particulate filter can be fabricated from any suitable medium consistent with the function described above. The particulate filter can be made from nonwoven material. The nonwoven material can include spun laced fibers selected from the group consisting of polyester fibers, rayon fibers, polyolefin fibers (e.g. polypropylene and blend fibers), cotton fibers, and blends thereof. In some embodiments the filter medium can include monofilaments of spun fiberglass such as is disclosed, for example, in U.S. Pat. No. 4,493,718 (Schweizer). In some embodiments, the particulate filter can include a first batting of high loft, non-woven, fibrous, fluid-permeable material with a plurality of openings formed through the thickness thereof across the length and width of the batting. A second layer of continuous, high loft, non-woven, fluid-permeable fibrous batting can be attached to the first layer and can extend across the entire length and width of the first layer as disclosed in U.S. Pat. No. 6,071,419 (Beier et al.). In other embodiments, the particulate filter can include fibers known as “electret” fibers that contain a permanent electrostatic charge imparted onto the media when it is being manufactured or a media comprised of an appropriate combination of dissimilar fibers which generates an electrostatic charge by virtue of the friction generated when air passes in very close proximity to the dissimilar fibers. A dielectric fiber such as polypropylene can be a suitable material for imparting permanent charge. For the media that includes dissimilar fibers combinations that have opposite polarities such as modacrylic and polypropylene can be used. These types of particulate filters are disclosed, for example, in U.S. Pat. No. 6,231,646 (Schweitzer et al.).

The provided particulate filtration system also includes a resilient two-dimensional porous prefilter located in proximity to the upstream surface of the grating (on the opposite side of the grate from the particulate filter). In some embodiments, the prefilter can be made of a nonwoven material that can trap paint droplets or dried paint particles but still is porous enough to allow passage of air through it. In other embodiments, the prefilter can be a woven fabric that has perforations in it. In this case, the perforations need to be small enough so that the prefilter traps paint droplets or dried paint particles but allows flow of air through it.

When the prefilter includes a nonwoven material, the prefilter typically has a thickness of from about 0.1 mm, from about 0.2 mm, or even from about 0.4 mm, to about 1.5 mm, to about 2.5 mm or even to about 3.0 mm. Any number of materials which are generally known in the art are suitable for making the nonwoven portion of the protection sheet described herein. As one of ordinary skill in the art will appreciate, the nonwoven material can be chosen to optimize: fiber surface area, inter-fiber bonding to prevent ‘linting’ or release of fibers which could also cause defects, fiber chemical composition, color, denier, or fiber basis weight. A nonwoven sheet derives its strength from chemical bonding or physical bonding (e.g. mechanical bonding) of its composite fibers. In the former process, the fibers may be coated with an adhesive resin which is cured or solidified to “resin-bond” the web. In the latter process, the fibers may be melt blown together in which blown fibers may bond together by mutual melting at a sufficient temperature.

Mechanical bonding entangles fibers to confer strength to the web, commonly by needle punching or spun lacing. In the latter method, jets of high-pressure water are directed at an incoming dry-laid web of non-bonded fibers. The jet action serves to highly entangle the web's fibers and yields a nonwoven of high strength. This process is described in, for example, U.S. Pat. No. 3,403,862 (Dworjanyn) and U.S. Pat. No. 3,485,706 (Evans). Spun laced fibers have the advantage of soft handle and conformability, sometimes referred to as drapability.

The nonwoven can include any useful fibers for nonwoven articles including those listed above as useful in the particulate filters of the provided particulate filtration system. Typically, the fibers can be made from polyester, polyolefins (e.g., polypropylene and blend fibers), cotton fibers, rayon fibers, and equivalents and blends thereof. The fiber size can be any useful size for forming a resilient two-dimensional network that can entrap paint droplets or particles and allows sufficient airflow to pass through to meet the requirements of a paint spray booth. Typically, the fibers have a diameter of from about 10 μm to about 30 μm. Nonwoven prefilters can have a typical average opening or aperture size of from about 0.5 mm² to about 10 mm².

When the prefilter includes a woven material, the woven material needs to include perforations to allow airflow therethrough. Woven materials that can be useful include any fabrics that are durable enough to withstand the force from a paint spray gun, the downdraft airflow from a paint spray booth, and abrasion from having vehicles, work carts, paint stands, etc. roll over them. Woven material can include polyesters, nylons, cellulosics such as rayon, cotton, or any other materials that can be spun into fibers and woven. It is important that woven materials have perforations to allow airflow. Typically woven materials useful in the provided particulate filtration system have perforations that have an average opening or aperture size of from about 0.5 mm² to about 10 mm².

The prefilter of the provided particulate filtration system is in proximity to the upstream surface of the grate. Since the grate in a paint spray booth is typically set into the floor to cover the filter pit, the prefilter is typically located on top of the grate, can be in contact with the grate, and is subject to vehicular traffic driving over it when vehicles are driven into the workspace for paint spray work. Additionally, the prefilter can be subject to abrasion from work carts and paint stands being rolled over it. The purpose of the prefilter is to act as a grate overspray containment system. In this capacity, the prefilter can both prevent overspray droplets and particles from forming on the grate and can prevent overspray droplets and particles that are already deposited on the grate from getting dislodged by the pressure of paint spray guns or the airflow around the article being painted. Dried paint released from the grate can bounce up onto the freshly painted surface. The use of a prefilter over the grate in the workspace for paint spraying can greatly reduce painting defects. Additionally, a prefilter can greatly increase the life of the particulate filter (typically, the primary exhaust filter) in a paint spray booth.

It is useful to provide a means for temporarily fastening the prefilter so that it covers the grating, cannot be displaced by vehicular traffic, and cannot be dislodged by the force of a paint spray gun or downdraft airflow. Fasteners can adhesives, spikes, hook-and-loop fasteners and magnets. For example, the prefilter can have a continuous or discontinuous strip of adhesive (typically, a pressure-sensitive adhesive) along its edges, adjacent to the sides of the grate, or both. In other embodiments, small spikes can be provided adjacent to the grate. The spikes can be small enough so that they do not puncture the tires of any vehicles driven over them but long enough to embed themselves into the prefilter and prevent it from sliding. In other embodiments, strips of hook-and-loop fasteners can be located adjacent to the grate on the floor of the paint spray booth. The prefilter then, optionally, have a matching set of hook-and-loop fasteners so that the prefilter can be spread out over the grate and fastened on its edges to the floor. Magnets can also be used as fasteners. Grates are typically metal. The prefilter can include magnets attached along the edge of the prefilter. The magnets can then adhere to the metal grate when the prefilter is positioned over the grate. Alternatively, magnets or magnetic strips can be placed on the floor or the grate and mating magnets or metal foil strips can be attached to the edges of the prefilter. Prefilters useful in the invention are two-dimensional and made of material that cannot tear into loose fibers from the shear of a vehicle, work cart, or paint stand rolling over it. The use of a fastener allows for the easy replacement of a spent prefilter with a new one. The use of such a prefilter can be an inexpensive, efficient, way to protect the vehicle from overspray defects and to increase the lifetime of the particulate filtration system.

Also provided is a structure for painting an article that includes a pair of spaced apart side walls, a ceiling supported by the side walls, and a floor located so that the ceiling and the floor join the side walls at the tops and the bottoms. In some embodiments, the structure is a paint spray booth. Paint spray booths are well known to those of ordinary skill in the art of spray painting. Exemplary paint spray booths are discussed, for example, in U.S. Pat. No. 4,673,425 (Hirs) and U.S. Pat. No. 5,034,042 (Allen, Jr.). Many paint spray booths useful as the provided structure are available from, for example, Finish Pro Spray Booths, Royse City, Tex., or Spray Systems, Inc., Pomona Calif.

The provided structure includes a particulate filtration system in contact with the floor. As discussed above and in the Figures below, the particulate filtration system typically is located at least partially in a filter pit below the floor. In this configuration, the filter pit typically includes a particulate filter, is covered by a grate that is substantially level with the floor, and is at least partially covered with a prefilter as described above. Typical structures include paint spray booths for vehicles, such as automobiles, trucks, buses, etc. The structures include a workspace that is located between the side panels, above the floor, and below the ceiling. The workspace is usually located above the particulate filter system. In operation, vehicles are driven into the workspace and then subjected to painting. During painting air is distributed to the work space from at least one of the ceiling panels or side panels and the air flows to an air exhaust located under the floor, under the particulate filtration system.

In another aspect, a method of preventing contamination is disclosed that includes a painting structure as described above that includes a particulate filtration system. An article to be painted, such as a vehicle, is introduced into the work space of the painting structure and then the article is painted, typically, using a paint spray gun. Air is circulated within the painting structure from around the painted article to form particulate-laden air. The particulate-laden air encompasses air that contains wet droplets or dry particulates of paint from the spray painting process and also includes wet droplets or dry particulates of paint that can be from other contaminated surfaces. The other contaminated surfaces can include, for example, unpainted or previously painted parts of the article, the sides, ceiling, or floor of the painting structure, or components of the particulate filtrations system such as the grate, as discussed above. The particulate-laden air is then passed through the particulate filtration system located in the floor to an exhaust system which can either exhaust the air outside of the structure or recycle it back through the structure. The article can include a vehicle or at least one part of a vehicle such as an outer panel. Outer panels can include doors, fenders, bumpers, hoods, roofs, side panels, or any paintable outer parts of the vehicle.

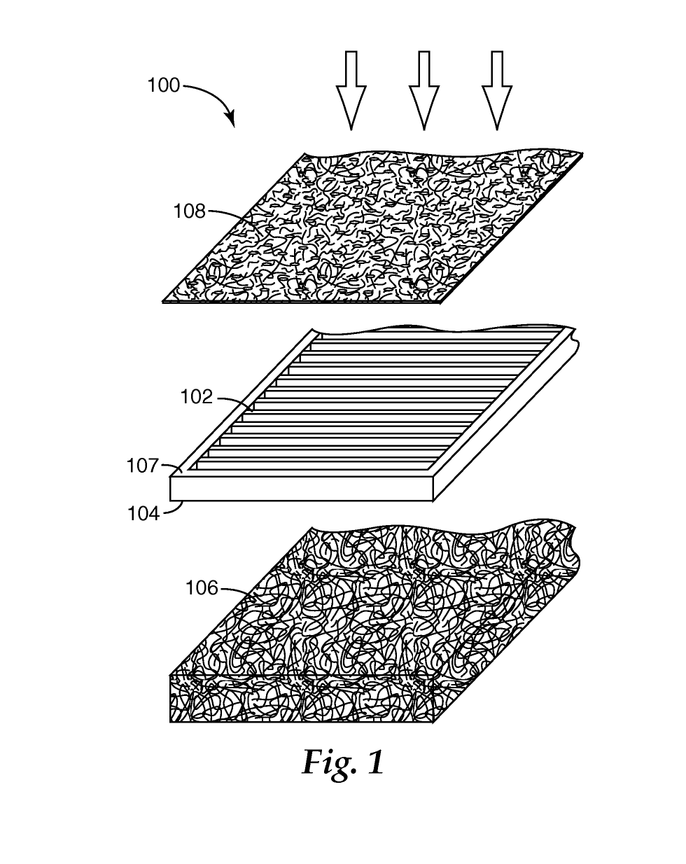

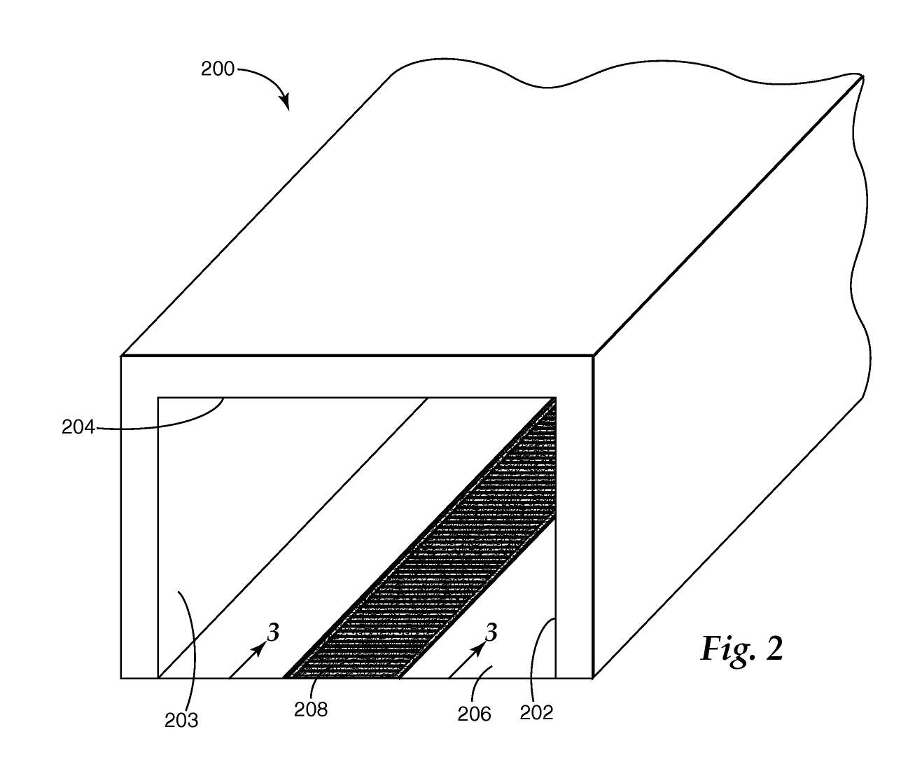

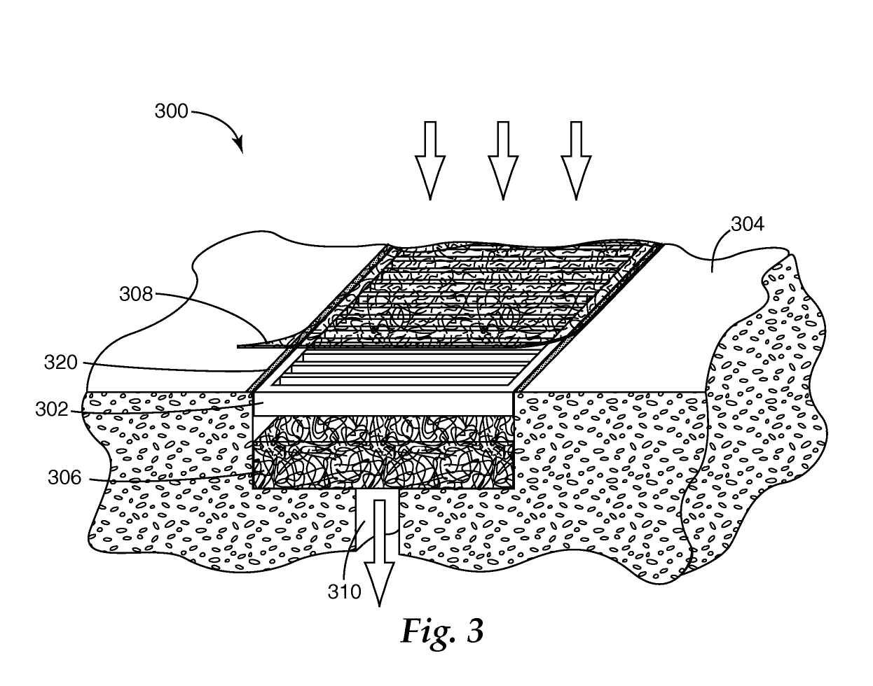

The present disclosure is further exemplified by looking at the Figures. FIG. 1 is an exploded view of an embodiment of a provided particulate filtration system 100. The particulate filtration system includes a grating 102 having a downstream surface 104 and an upstream surface 107. Particulate filter 106 is located in proximity to downstream surface 104 of grate 102. Resilient two-dimensional porous prefilter 108 is located in proximity to upstream surface 107 of grate 102. Particulate filtration system 100 is located in the floor of a paint spray booth as shown in FIGS. 2 and 3. Particulate-laden air from the paint spray workspace (not illustrated) is circulated through particulate filtration system 100 in the direction shown by the arrows.

FIG. 2 is an illustration of structure 200 that is used to paint vehicles. Structure 200 includes two spaced apart side walls 202 and 203, ceiling 204 supported by the side walls 202 and 203, and floor 206. Particulate filtration system 208 is located partially embedded in floor 206. In this illustration only the grate of particulate filtration system 208 is shown. In this embodiment, grate 208 is embedded into, and flush with floor 208 enabling vehicles to be driven into and out of the workspace inside of structure 200.

FIG. 3 is cut-away view of the details of particulate filtration system 300 which is partially shown in FIG. 2. Particulate filtration system 300 includes grate 302 that is embedded in and flush with floor 304 of a structure (not indexed) used to paint vehicles. Particulate filtration system 300 includes particulate filter 306 in proximity to the downstream surface of grate 302. Air exhaust manifold 310 is located below the particulate filtration system (on the downwind side). Particulate-laden air flows from the work space above floor 304, around the painted vehicle (not shown), through prefilter 308, grate 302, and particulate filter 306 and out air exhaust manifold 310 as shown by the direction of the arrows. Resilient two-dimensional prefilter 308 is located in proximity to the upstream surface of grate 302 as shown in the illustration. Floor 304 has strips 320 of a hook fastener adjacent to the sides of grate 320. Prefilter 308 has a width that exceeds that of grate 302 so that it can contact strips 320 of hook fastener 320. In some embodiments, prefilter 308 can have mating loop strips on the side nearest to the grate.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

What is claimed is:

1. A system for filtering particulate matter from an airstream flowing through the system, the system comprising:
a grate having an upstream surface and a downstream surface opposite the upstream surface;
a two-dimensional prefilter located in proximity to the upstream surface of the grate; and
a particulate filter located in proximity to the downstream surface of the grate.

2. A filtration system according to claim 1, wherein the prefilter comprises a nonwoven material.

3. A filtration system according to claim 2, wherein the prefilter comprises a woven material that has perforations.

4. A filtration system according to claim 3, wherein the perforations have an average diameter of from about 0.5 mm to about 10 mm.

5. A filtration system according to claim 2, wherein the nonwoven material has average openings of from about 0.5 mm to about 10 mm.

6. A filtration system according to claim 2, wherein the porous prefilter comprises at least one of a spunlaced or a hydroentangled nonwoven polyester.

7. A filtration system according to claim 2, wherein the nonwoven comprises fibers with an average diameter of less than about 30 microns.

8. A filtration system according to claim 1, wherein the porous prefilter is resilient.

9. A structure comprising an enclosure having a floor, an exhaust air filter pit in the floor, a grate mounted in the exhaust air filter pit, a two-dimensional prefilter overlying an upper surface of the grate, and a particulate filter in proximity to and beneath the grate.

10. A structure according to claim 9 wherein the prefilter is at least partially in contact with the upstream surface of the grate.

11. A structure according to claim 10 wherein the prefilter is attached to the floor, the grate, or both, with a fastener.

12. A structure according to claim 11 wherein the fastener comprises an adhesive strip on the floor, a hook-and-loop strip on the floor, or a combination thereof.

13. A structure according to claim 10 wherein the prefilter comprises a fastener.

14. A structure according to claim 10 wherein the porous prefilter comprises at least one of a spunlaced or a hydroentangled nonwoven polyester.

15. A structure according to claim 10 wherein the nonwoven polyester comprises fibers with an average diameter of less than about 30 microns.

16. A method of reducing contamination comprising:
providing a painting structure that includes a work space, a floor, a ceiling, at least two side panels, and a particulate filtration system located in the floor;
introducing an article into the work space;
spraying the article with paint;
circulating air from at least one of the ceiling or the side panels around the article to form particulate-laden air;
passing the particulate-laden air through a particulate filtration system located in the floor to an exhaust system; and
allowing the paint to dry in the circulating air,
wherein the particulate filtration system comprises:
a grate having an upstream surface and a downstream surface opposite the upstream surface;
a two-dimensional prefilter located in proximity to the upstream surface of the grate; and
a particulate filter located in proximity to the downstream surface of the grate.

17. A method according to claim 16 wherein the article comprises at least one outer panel of a vehicle.

18. A method according to claim 16 wherein the particulate filter, the prefilter or both comprise a nonwoven material.

19. A method according to claim 18 wherein the prefilter comprises at least one of a spunlaced or a hydroentangled nonwoven polyester.

20. A method according to claim 19 wherein the nonwoven polyester comprises fibers with an average diameter of less than about 30 microns.
